(19) United States
(12) Patent Application Publication
(10) Pub. No.: US 2022/0351287 A1
(43) Pub. Date: Nov. 3, 2022

(54) SYSTEMS, DEVICES, AND METHODS FOR COUPLED, CUSTOMIZED TRANSACTIONS REFERENCING INDEFINITE, YIELD- AND RISK-BASED INSTRUMENTS WITH OPTIONALITY TO OPTIMIZE MULTI-LATERAL INCENTIVE ALIGNMENT

(71) Applicant: PARK AVENUE FINANCE, New York, NY (US)

(72) Inventors: Nathan Pierce, New York, NY (US); Jared Olson, McLean, VA (US)

(21) Appl. No.: 17/600,032

(22) PCT Filed: Mar. 28, 2020
(86) PCT No.: PCT/US2020/025559

§ 371 Date: Sep. 29, 2021

Related U.S. Application Data
(60) Provisional application No. 62/826,390, filed on Mar. 29, 2019.

(51) Int. Cl. G06Q 40/04; G06Q 40/06

(52) U.S. Cl. CPC G06Q 40/04; G06Q 40/06

(57) ABSTRACT

Techniques described herein may enable implementation of systems and devices (e.g. user computers, server devices, clusters of servers, etc.) that determine, create, execute, monitor, and manage coupled and customized transactions involving indefinite, yield- and risk-based instruments with optionality to enhance organizational value and create incentive alignment between transacting entities (e.g. individuals, organizations, and other types of entities) not otherwise disposed to collaboration.

### BACKGROUND

Systems (e.g. computer networks, telecommunication networks, etc.) and devices (e.g. smartphones, tablet computers, laptop computers, servers, etc.) can be configured with different types of hardware and software to enable the systems and/or devices to provide one or more of a variety functions. The hardware and/or software implemented in a system and/or device may vary greatly in terms of capacity, complexity, sophistication, utility, and more. Some systems and/or devices may be configured to support relatively common functions, such as file management and editing solutions, browser and networking capabilities, data storage, etc., whereas other systems and devices may be configured to support highly complex and specialized functions, which may involve demanding data processing and analysis operations, generating specialized and diverse data sets, producing high-value outputs, etc.

### BRIEF DESCRIPTION OF THE DRAWINGS

Embodiments described herein will be readily understood by the following detailed description in conjunction with the accompanying drawings. To facilitate this description, like reference numerals may designate like structural elements. Embodiments are illustrated by way of example and not by way of limitation in the figures of the accompanying drawings.

FIG. 1 is an example environment in which one or more of the devices, systems, and methods, described herein, may be implemented;

FIG. 2 is a flowchart diagram of an example process for creating and executing coupled and customized transactions involving indefinite, yield- and risk-based instruments with optionality to create multi-lateral incentive alignment between companies in accordance with one or more embodiments described herein;

FIG. 3 is a block diagram of example data structures for determining capabilities and objectives of a company in accordance with one or more embodiments described herein;

FIG. 4 is a block diagram of example data structures for determining optimal companies for engaging in customized and coupled warrant transactions for optimized multi-lateral incentive alignment in accordance with one or more embodiments described herein;

FIG. 5 is a diagram of an example of changes in company values from determining and executing coupled and customized transactions with optionality for optimized multi-lateral incentive alignment in accordance with one or more embodiments described herein;

FIGS. 6-7 are block diagrams of examples of interests in a company that may be referenced in a given option or warrant transaction in accordance with one or more embodiments described herein;

FIG. 8 is a flowchart diagram of an example process 800 for determining optimal terms for customized and coupled warrant transactions for optimized multi-lateral incentive alignment in accordance with one or more embodiments described herein;

FIG. 9 is a block diagram of example data structures for recording customized and coupled warrant transactions for optimized multi-lateral incentive alignment in accordance with one or more embodiments described herein;

FIG. 10 is a flowchart diagram of an example process for monitoring, managing, and executing warrants in accordance with one or more embodiments described herein;

FIG. 11 is a block diagram illustrating components of a system configured to support network function virtualization (NFV) in accordance with one or more embodiments described herein; and

FIG. 12 is a diagram of example components of a device in accordance with one or more embodiment described herein.

### DETAILED DESCRIPTION OF PREFERRED EMBODIMENTS

The following detailed description refers to the accompanying drawings. The same reference numbers in different drawings may identify the same or similar elements. It is to be understood that other embodiments may be utilized, and structural or logical changes may be made without departing from the scope of the present disclosure. Therefore, the following detailed description is not to be taken in a limiting sense.

Economic participants may include a variety of entities or organizations, such as individuals, companies, non-profit organizations, academic or research institutions, government agencies, etc. For simplicity, such entities may be individually or collectively referred to herein as “company” or “companies.” In many scenarios, companies may engage in transactions that include an exchange of monetary assets (e.g. cash) for an interest in another company, including stock or an enforceable right to decide whether to purchase a type of stock at a specified price and at a specified date (also referred to as a stock option, stock warrant, etc.). A stock option or stock warrant may be collectively referred to herein as a warrant, and a transaction involving a warrant may be referred to herein as a warrant transaction.

While warrant transactions may benefit transacting companies to a certain extent, typical warrant transactions fail to establish an alignment of interests between the transacting companies. For example, if a first company purchases a warrant from a second company, the welfare of the first company may depend (at least in part) on the welfare of the second company; however, the welfare of the second company may not depend on the welfare of the first company because the second company already received its benefit from the warrant transaction upon receiving cash in exchange for the warrant. As such, typical warrant transactions fail to create an alignment of interests affected by (a) the individual success of a first company, (b) the individual success of a second company, and (c) the mutual success of both transacting companies.

Additionally, most warrant transactions involve the purchase of price-based instruments, such as common stock, such that the value of the option is based on the current market value of the price-based instrument (e.g. the common stock), the purchase price at which the warrant may be exercised to acquire the price-based instrument, and the time horizon over which the purchase option may be exercised. In such a scenario, while the market value of the stock may be known, the final value of the stock is undetermined as the value of the stock will likely change before expiration or maturity date of the warrant. Far less common are warrant transactions that involve fixed income instruments, such as bonds, which may be traded primarily based on the yield and risk components of the instrument (which translate to price, but are not fundamentally price-based). For example, the price of a bond may be based on a combination of the yield (e.g. fixed income) specified by the bond and the probability (e.g. risk) of whether the bond issuer will be able and willing to honor the various payments due in respect of the bond through maturity.

As such, warrant transactions are not commonly transacted with respect to yield- and risk-based instruments, particularly those that create an indefinite ownership interest in the selling company, such as perpetual preferred stock. Unlike common stock, where value is based on the price of the stock, the value (e.g. price) of perpetual preferred stock may be based on the anticipated yield (e.g. anticipated dividend payments, increased value of the stock over time, etc.) and the probability (e.g. risk) of whether the selling company may perform in accordance with the anticipated yield. In addition, unlike a bond, perpetual preferred stock may not include a definite promise of payment or maturity date. Instead, perpetual preferred stock may grant a perpetual ownership interest in the selling company, and an expectation of periodic dividend payments, without a definite promise of yield or time-specific return of capital (e.g. interest and principal payments, etc.). As such, transactions involving perpetual preferred stock may provide a way to align the long-term interests of one company (e.g. the purchasing company) toward the interests of another company (e.g. the selling company) since perpetual preferred stock is a yield- and risk-based instrument that creates an ownership interest with no maturity or expiration date. Nevertheless, while such a transaction may align the interests of the purchasing company toward the interests of the selling company (the purchasing company benefits from the continued success of the selling company), such a transaction may fail to align the long-term interests of the selling company with those of the purchasing company since the selling company may have already realized its benefit from the transaction by receiving cash in exchange for the issuance of the perpetual preferred stock.

Techniques described herein may enable implementation of systems and devices (e.g. user computers, server devices, clusters of servers, etc.) that determine, create, execute, monitor, and manage coupled and customized multi-lateral transactions involving indefinite, yield- and risk-based instruments with optionality to 1) enhance the value of the transacting companies; and 2) create long-term incentive alignment between the companies. For example, a first warrant transaction may include a first company exchanging a first monetary amount (e.g. cash) for a warrant referencing perpetual preferred stock in a second company, and the second transaction may include the second company exchanging a second monetary amount (e.g. cash) for a warrant referencing perpetual preferred stock in the first company. Since perpetual preferred stock may include yield- and risk-based instruments, where the anticipated yield, estimated risk, etc., may be particular, or relatively unique, to the selling company, the terms of each warrant transaction (e.g. monetary amounts, warrant price, exercise price, etc.) may be highly customized according to the relative capabilities and opportunities of each company.

Additionally, the systems and/or devices, described herein, may be configured to substantively couple each set of warrant transactions by determining the terms of one warrant transaction based (at least in part) on one or more of the terms of the other warrant transaction and vice versa. Upon determining an initial set of hypothetical warrant transactions between the companies, the systems and/or devices described herein may analyze and forecast the impact of the hypothetical warrant transactions on the future probability and degree of success of each company (since, for example, executing the hypothetical warrant transaction may change the monetary assets available to each company, create incentive alignment, etc., and thereby have a significant impact on the risk and yield expectations applied to the hypothetical warrant transactions). The systems and/or devices may generate additional hypothetical warrant transactions (each with different terms), determine the corresponding impact of each set of hypothetical warrant transactions, and select the hypothetical warrant transactions associated with the optimal impact for the transacting companies.

Furthermore, since the reference asset for each warrant transaction may include perpetual preferred stock, the dynamically generated and highly customized transactions may optimize incentive alignment between the companies since the ultimate yield of each warrant transaction may be based on the performance of the selling company. More particularly, the purchasing company in a first warrant transaction may be directly incentivized to help maximize the value and success of the selling company because doing so may maximize the yield of the perpetual preferred stock referenced in the first warrant transaction. Additionally, since the first warrant transaction is coupled to a second warrant transaction that is directionally opposite to the first transaction, the purchasing company in the second warrant transaction may be similarly incentivized to aid in maximizing the value and success of the selling company of the second transaction, thereby creating incentive alignment between the transacting companies. Moreover, as each warrant transaction may reference perpetual preferred stock the incentive alignment between the companies may be ongoing and indefinite as the perpetual preferred stock may have no expiration or maturity date. Accordingly, the techniques described herein may include systems and devices configured to dynamically determine customized and coupled, yield- and risk-based transactions with optionality that optimize long-term incentive alignment between companies. Additional features, processes, benefits, and advantages enabled by the systems and devices, described herein, are discussed in detail below with reference to the Figs. presented herein.

In some embodiments, techniques described herein may create bilateral incentive alignment (e.g. when 2 companies are involved) or multi-lateral incentive alignment (e.g. when 2 companies and one or more subsidiary entities are involved. For example, a first company may sell warrants to a second company, a subsidiary of the second company may sell warrants to the first company (and/or a subsidiary of the first company), such that direct and/or indirect incentive alignment may be created between more than two participating entities. As such, examples, embodiments, etc., herein that reference a company or other transacting entity may include or be applicable to examples, embodiments, etc., involving sub-entities of the company or other transacting entity.

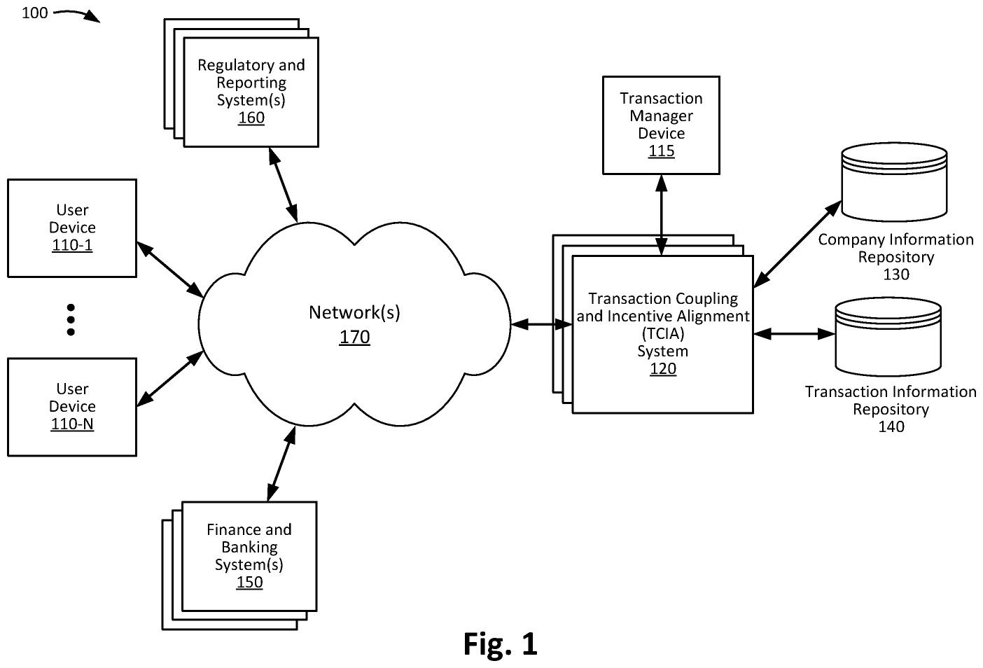

FIG. 1 is an example environment 100 in which one or more of the devices, systems, and methods, described herein, may be implemented. As shown, environment 100 may include user devices 110-1 through 110-N (referred to collectively as “user devices 110” or individually as “user device 110,” where N is an integer greater than 1), transaction manager device 115, transaction coupling and incentive alignment (TCIA) system 120, company information repository 130, transaction information repository 140, finance and banking system 150, and regulatory and reporting system 160. Environment 100 may also include network 170 that may include one or more types of networks, and/or combinations thereof, and that may enable one or more of the systems and devices, of FIG. 1, to communicate with one another.

The quantity of systems, devices, and/or networks, illustrated in FIG. 1, is provided for explanatory purposes only. In practice, environment 100 may include additional systems, devices, and/or networks; fewer systems, devices, and/or networks; different systems, devices, and/or networks; or differently arranged systems, devices, and/or networks than illustrated in FIG. 1. For example, while not shown, environment 100 may include devices that facilitate or enable communication between various devices/components shown in environment 100, such as routers, modems, gateways, switches, hubs, power sources, etc. Alternatively, or additionally, one or more of the systems and/or devices of environment 100 may perform one or more functions described as being performed by another system and/or device of environment 100. For example, while a certain functionality (or portion thereof) may be described herein as being performed by TCIA system 120, in alternative examples and/or scenarios, the functionality (or portion thereof) may also, or alternatively, be performed by one or more other systems or devices, such as user device, 110, transaction manger device 115, finance and banking system 180, and so on.

Additionally, the systems and/or devices of environment 100 may interconnect with each other, and/or other systems and/or devices not shown, via wired connections, wireless connections, or a combination of wired and wireless connections. In some implementations, one or more systems and/or devices of environment 100 may be physically integrated in, and/or may be physically attached to, one or more other systems and/or devices of environment 100. For example, in some embodiments, TCIA system 120 and transaction manager device 115 may be implemented as the same device, which may include a type of user device 110. In another example, user device 110 may communicate with TCIA system 120 via a non-proprietary network, such as the Internet, while transaction manger device 115 may communicate with TCIA system 120 via a proprietary network, such as a local wireless network that is owned and operated by a private company or other organization. As such, the techniques, described herein, are not to be interpreted as being limited by example environment 100.

Further, the systems and/or devices of environment 100 may be owned and/or operated by one or more individuals and/or organizations depending on a given scenario, implementation, embodiment, etc. An organization, as described herein, may include one or more of a variety of social, legal, and/or economic entities, including a public or private company, government agency or institution, independent regulatory body, academic institution, charitable organization, and more. For practical context, some of the aspects, features, examples, scenarios, etc., of the techniques described herein may be described in the context of one or more companies. However, such descriptions are provided as non-limiting examples, as the techniques described herein may also be applicable to other types of organizations and scenarios.

User device 110 may include a non-portable computing device and communication device, such as a desktop computer, a computer terminal, a computerized work station, etc. User device 110 may also, or alternatively, include a portable computing and communication device, such as a personal digital assistant (PDA), a smart phone, a cellular phone, a laptop computer, a tablet computer, a wearable device (such as a watch), etc. Generally, user device 110 may include a combination of computer hardware and software that enables user device 110 to interact with users by receiving input from users and communicating output to users. User device 110 may also, or alternatively, be configured to communicate with one or more other devices, which may consist of other user devices 110, transaction manager device 115, TCIA system 120, one or more other network devices (e.g. routers, hubs, data repositories, etc.), etc. In some embodiments, user device 110 may be part of, or otherwise communicate with, one or more proprietary networks (e.g. a network that is owned, operated, managed, and maintained by an individual, company, or other type of organization) and/or a non-proprietary network (e.g. the Internet).

In some embodiments, user device 110 may be owned and operated by an organization investigating, analyzing, enabling, and/or participating in warrant transactions as described herein. In some embodiments, user device 110 may enable a user to provide TCIA system 120 with information used by TCIA system 120 to analyze interests, capabilities, objectives, and/or other types of characteristics of a company, determine terms of warrant transactions, execute and monitor warrant transactions, exercise optionality, etc. In some embodiments, user device 110 may also provide a way by which TCIA system 120 may communicate information to a user, including a party to a transaction, an administrator or professional representing a party to a transaction etc. As such, the techniques described herein include user device 110 being configured in one or more of a wide variety of particular and/or specialized ways that may cause, enable, etc., user device 110 to be complementary to one or more of any of the other processes, features, techniques, etc. described herein.

Transaction manger device 115 may include a user device 110 configured to enable an administrator, transaction manager, analyst, or other authorized individual to manage, monitor, and configure TCIA system 120. In some embodiments, transaction manger device 115 may enable a transaction manager to provide TCIA system 120 with transaction information (e.g. information about one or more parties, terms, assumptions, constraints, parameters, etc.) that TCIA system 120 may use to determine terms of a warrant transaction, identify a suitable counter party to a warrant transaction, ensure that a warrant transaction comports with a recommendation, regulation, or standard, etc. Transaction manger device 115 may also provide a user interface to enable a transaction manger to review, verify, modify, and authorize transactions proposed by TCIA system 120, including the parties to the proposed transaction, terms of the proposed transactions, proposed level of synergy between the transacting parties, and so on. In some embodiments, transaction manger device 115 may enable a transaction manger to flag proposed transactions for further review, escalate proposed transactions for review by another group or individual, reject proposed transactions (e.g. transactions that are flawed, fail to comport with internal guidelines or standards, etc.) and provide the transaction manager with access to other managerial tools and oversight information regarding one or more aspects the warrant transaction creation, execution, monitoring, and feedback-based improvement techniques described herein.

TCIA system 120 may include one or more computing devices, such as a server or a cluster of server devices, capable of receiving, processing, and producing data in accordance with hardware components (e.g. processors, memory, storage, communication interfaces, etc.) and/or software (e.g. an operating system, software tools, features, and applications, etc.) thereof. TCIA system 120 may also include one or more types of data repositories (e.g. databases and storage device) configured to store various types of value-add information to the overall function and processes of TCIA system 120. TCIA system 120 may also include one or more user terminals or another type of administrative/management device that enables one or more users to communicate with TCIA system 120. As described in detail below with reference to subsequent Figures, TCIA system 120 may be configured to perform a variety of operations, processes, and functions, including receiving, analyzing and determining information relating to qualities, capabilities, opportunities, interests, and characteristics of companies, determining terms and other characteristics of warrant transactions, and proposing, executing, monitoring, managing, etc., the coupled and customized warrant transactions as described herein.

Company information repository 130 may include one or more computing and/or data storage devices, which many include one or more databases and/or other types of data organization and storage structures, configurations, and corresponding capabilities deployed on one or more server devices. In some embodiments, company information repository 130 may include information about qualities, capabilities, opportunities, interests, and/or characteristics of different companies, which may or may not have participated in a coupled and customized warrant transaction generated by TCIA system 120. In some embodiments, the information stored by company information repository 130 may have originated from a user, including an individual authorized to operate on behalf of and provide information about a particular company, a technician or administrator of TCIA system 120, third-party analyst, government or regulatory personnel, or another type of user. Additionally, or alternatively, information stored by company information repository 130 may include data generated by TCIA system 120 (e.g. metrics, quantified characteristics and capabilities, etc.) based on operations, processes, algorithms, etc., executed by TCIA system 120. In another example, information stored by company information repository 130 may be received from external systems and/or devices, including information made available by a government or regulatory agency, external analyst and/or data collection and analysis services, and so on.

Transaction information repository 140 may include one or more computing and/or data storage devices, which many include one or more databases and/or other types of data organization and storage structures, configurations, and corresponding capabilities deployed on one or more server devices. In some embodiments, transaction information repository 140 may include data corresponding to transactions generated, proposed, executed, etc., by TCIA system 120 (e.g. coupled and customized transactions involving indefinite, yield- and risk-based instruments with optionality). In some embodiments, transaction information repository 140 may include details (e.g. terms) of transactions, parties to transactions, characteristics about the parties to transactions, iterations and alterations to transactions prior to execution (e.g. while being negotiated) and more. In some embodiments, transaction information repository 140 may also, or alternatively, include information memorializing synergistic incentive alignment between transacting companies, records of collaborative economic events and developments resulting from the incentive aligning transactions, etc.

Maintaining records of transactions may better enable TCIA system 120 to monitor and manage ongoing transactions, enable parties to evaluate, acquire, and exercise the optionality of transactions, and provide a foundational dataset for increasing the effectiveness and efficiency with which TCIA system 120 may determine the terms of similar or analogous transactions (e.g. subsequent transactions involving similar companies, amounts, scenarios, industries, etc.), and/or to which TCIA system 120 may apply machine learning and other types of artificial intelligence and self-optimization techniques to enhance one or more of the configurations and/or operations of TCIA system 120 as described herein. Additionally, or alternatively, maintaining records of transactions may better enable TCIA system 120 to operate well within any applicable industry standards, party preferences, government and regulatory compliance requirements or recommendations (which may change post-execution), lawfully provide transaction information to third-parties, such as government agencies, regulatory organizations, research institutions, and other companies, etc.

Finance and banking system 150 may include one or more computing devices, such as a server or a cluster of server devices, capable of receiving, processing, and producing data in accordance with hardware components (e.g. processors, memory, storage, communication interfaces, etc.) and/or software (e.g. an operating system, software tools, features, and applications, etc.) thereof. Finance and banking system 150 may also include one or more types of data repositories (e.g. database systems) configured to store various types of value-add information to the overall function and processes of providing finance and/or banking services. In some embodiments, finance and banking system 150 may be configured to digitally monitor and/or manage various financial accounts, execute the transfer of monetary assets between accounts and account holders, and provide other types of electronic banking services. In some embodiments, finance and banking system 150 and TCIA system 120 may be configured to cooperate in the execution of coupled and customized transactions as described herein. For example, upon receiving a request to execute a pair of customized transactions, TCIA system 120 may notify finance and banking system 150 that the transactions are to be executed, upon which finance and banking system 150 may execute the specified transfer of monetary assets as defined by the customized transactions. In some embodiments, prior to executing the transactions, finance and banking system 150 may verify that the specified accounts and/or transacting entities have adequate funds, provide oversight, security, and verification of fund transfers, and report to TCIA system 120 when and/or whether the specified transactions were successful. As such, finance and banking system 150 may provide a variety of one or more finance, banking, and/or transaction support services to TCIA system 120. In some embodiments, some or all of finance and banking system 150 may be owned and operated by the same organization as TCIA system 120. In some embodiments, some or all of finance and banking system 150 may be owned and/or operated by one or more different organizations, such as one or more banks, financial institutions asset management companies, etc.

Regulatory and reporting system 160 may include one or more computing devices, such as a server or a cluster of server devices, capable of receiving, processing, and producing data in accordance with hardware components (e.g. processors, memory, storage, communication interfaces, etc.) and/or software (e.g. an operating system, software tools, features, and applications, etc.) thereof. Regulatory and reporting system 160 may also include one or more types of data repositories (e.g. database systems) configured to store various types of information consistent with a regulation or standard pertaining to financial instrument transactions. In some embodiments, regulatory and reporting system 160 may be owned and operated by a government agency, regulatory body, designated industry oversight organization, and/or one or more other types of groups. In some embodiments, TCIA system 120 may communicate with regulatory and reporting system 160 to verify whether a particular company may participate in particular transaction, verify whether terms of a proposed transaction are consistent with one or more standards, regulations, and/or recommendations, report transactions (including one or more details thereof) that have been formalized and executed, receive and respond to lawful information requests from regulatory and reporting system 160 by providing records of executed transactions involving specified companies, industries, dates, date ranges, monetary amounts (e.g. above or below a specified threshold), etc. As such, the techniques described herein include solutions for ensuring a high degree of standards compliance and regulatory cooperation, oversight, and transparency regarding coupled and customized warrant transactions involving indefinite, yield- and risk-based instruments with optionality.

Network 170 may include one or more wired and/or wireless networks. For example, network 170 may include a local area network (LAN), a wireless LAN (WLAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks. Additionally, or alternatively, network 170 may include a telecommunications network (e.g. a basic telephony network, a second generation (2G) network, a third generation (3G) network, a fourth generation (4G) network, a Long-Term Evolution (LTE) network, a fifth generation (5G) network, a New Radio (NR) network, a global system for mobile (GSM) network, a code division multiple access (CDMA) network, an evolution-data optimized (EVDO) network, etc.), a public land mobile network (PLMN), and/or another type of network).

One or more of the systems and/or devices of FIG. 1 may be implemented as one or more physical devices and/or servers. Additionally, or alternatively, one or more of the systems and/or devices of FIG. 1 may be implemented as virtual devices and/or one or more of the functions of one or more systems and/or devices may be implemented as a VNF and/or another type of virtual, abstract, and/or functional implementation and representation. For instance, user devices 110, transaction manager device 115, TCIA system 120, etc., may be implemented by physical computing devices. Additionally, or alternatively, one or more devices (e.g. user devices 110, transaction manager device 115, TCIA system 120, etc.,) and/or one or more features or functions thereof, may be implemented as VNF deployed in, for example, a cloud computing environment with suitable resources (e.g. processing capacity, memory capacity, storage capacity, etc.) for implementing virtual devices, VNFs, and/or other types of dynamic network arrangements and implementations. As such, the techniques described herein may include a variety of implementations of computer systems, networks, and devices that are specially designed to create an entirely new digital platform and technical environment for determining, executing, monitoring, managing, analyzing, and optimizing coupled and customized transactions of indefinite, yield- and risk-based instruments with optionality.

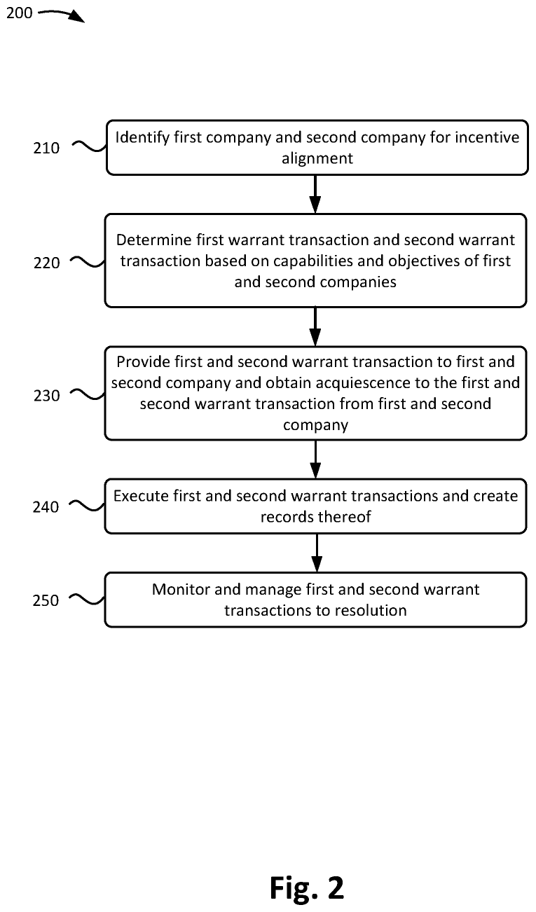

FIG. 2 is a flowchart diagram of an example process 200 for creating and executing coupled and customized transactions involving indefinite, yield- and risk-based instruments with optionality to create multi-lateral incentive alignment between companies. In some implementations, process 200 may be implemented by TCIA system 120. In some embodiments, some or all of process 200 may be performed by one or more other systems or devices, including one or more of the devices of FIG. 1. While FIG. 2 represents process 200 as a sequence of operations, the sequence of the operations, arrangement of the operations, etc., does not limit the scope of the techniques described herein.

As shown, process 200 may include identifying a first company and second company for incentive alignment (block 210). For example, TCIA system 120 may identify companies suitable for engaging in coupled transactions for incentive alignment purposes. The coupled transactions may involve each company purchasing warrants referencing indefinite, yield- and risk-based interest (e.g. perpetual preferred stock) in the other company.

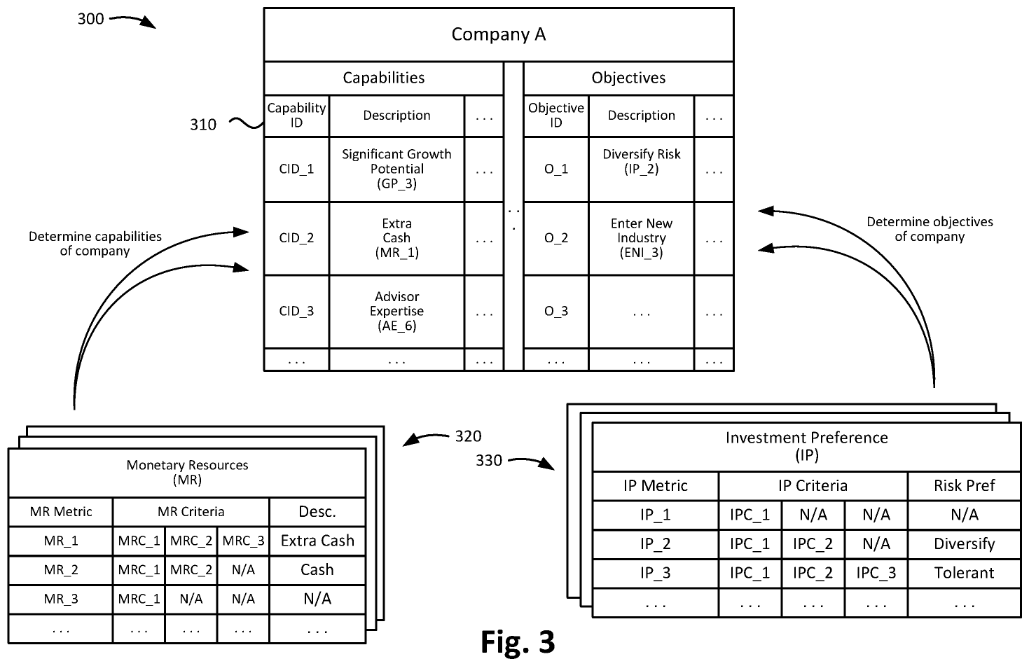

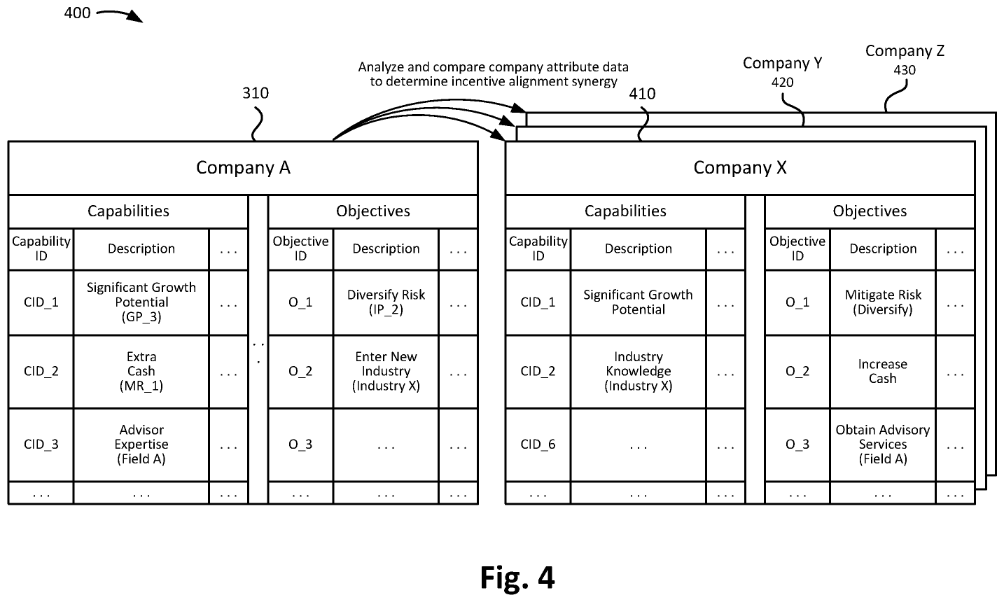

In some embodiments, TCIA system 120 may identify companies suitable for coupled transactions by evaluating the characteristics, capabilities, and objectives of each company with respect to other companies. Examples of characteristics, capabilities, and objectives may include a company's risk tolerance, ability to invest in other companies, a degree and likelihood of the company increasing in value over a given period of time, economic or other types of goals and preferences of a company, and more. TCIA system 120 may execute one or more algorithms, data processing functions, etc., whereby one or more qualitative and/or quantitative characteristics, capabilities, and/or objectives of a company may be quantized for comparison, analysis, indexing, measuring, and processing (e.g. to determine whether warrant transactions may be effective in establishing multi-lateral incentive alignment between different companies). In some embodiments, additional and/or alternative mechanisms, measurements, tools, etc., may be used to identify companies suitable for coupled, incentive-aligning transactions. Identifying such companies is described below in additional detail with reference to FIGS. 3-4. In some embodiments, TCIA system 120 may determine the characteristics, capabilities, and/or objectives of a large number of companies, create records of each company, and store the records in a centralized repository, such as company information repository 130. Doing so may provide TCIA system 120 is with a database of companies to be matched for customized and coupled warrant transactions as described herein.

Process 200 may also include determining a first warrant transaction and a second warrant transaction to optimize incentive alignment between the first and second companies, based on the characteristics, capabilities, and objectives of the first and second companies (block 220). For example, TCIA system 120 may determine the terms of the coupled transactions that may align the interests of each company based on the characteristics, capabilities, and objectives of each company. For example, a purchase capacity metric of a first company may be relatively high because of high levels of monetary assets, significant and/or expected gains, increased revenue, etc., and an objectives metric of a second company may also be relatively high due to forecasted and foreseeable events that are likely to increase the value of the second company. As such, TCIA system 120 may determine the terms of a first transaction based on the relatively high purchase capacity metric of the first company, the relatively high opportunity metric of the second company, and/or one or more other characteristics, capabilities, and objectives of the first and second companies.

In some embodiments, TCIA system 120 may determine an opportunity metric for a company, which may represent a probability and degree to which the company may experience a value-creating event, development, or other occurrence in the foreseeable future. TCIA system 120 may also determine a purchase capacity metric for the company, which may represent an ability of the company to purchase warrants or options involving indefinite, yield- and risk-based instruments of other companies. For example, when a company has increased monetary assets (e.g. cash), has recently realized capital gains, is expected to realize capital gains in the foreseeable future, etc., the purchase capacity metric for the company may be relatively high. TCIA system 120 may determine an incentive alignment probability and/or degree metric between different companies, which may indicate, represent, etc., a probability and/or degree to which the incentives of each company may be aligned by engaging in coupled transactions involving options to purchase indefinite, yield- and risk-based instruments from the other company.

For example, an incentive alignment probability and degree metric between companies may be relatively high where a first company is well-positioned to be a client or customer of a second company. Similarly, an incentive alignment probability metric between companies may be relatively high when a first company is well-known, reputable, etc., in an industry or economic sector comprising potential customers for products or services provided by a second company (e.g. such that the first company may be well-positioned to provide the second company with referrals or other types of client-development introductions). As such, while merely purchasing warrants or options to later buy perpetual preferred stock in another company may unilaterally align the interests of the purchasing company with the selling company, TCIA system 120 may be configured to further determine the potential for aligning the interests of companies based on factors, conditions, and/or characteristics that are not inherent to the transaction itself, and by doing so, TCIA system 120 may determine optimal companies for incentive alignment.

In some embodiments, warrant transaction terms may include a warrant target value, reference asset value, risk free rate, effective date, expiration date, duration to maturity, volatility, and warrant dividend rate. A warrant target rate may be an assumed or pre-specified value of a company's warrant. A reference asset value may include the value of the asset referenced by a warrant. In some embodiments, a reference asset value of a first transacting company may be determined by applying an assumed or pre-specified multiple to the targeted warrant reference asset value of the first transacting company. Additionally, or alternatively, the reference asset value of a second transacting company may be determined by applying an assumed or pre-specified ratio or percentage to the reference asset value of the first transacting company.

A risk free rate may include an assumed or pre-specified percent return that might otherwise be achieved without risk or at a very low risk. An effective date may include one or more dates when each company purchases the options or warrants of the other company per the coupled and customized transaction. An expiration date may include the date upon which the corresponding warrants or options (e.g. to by the indicated reference asset) expire. The volatility may include an assumed or pre-selected level of volatility corresponding to the anticipated or perceived variability (in both frequency and quantum) of the value of the reference asset. A warrant dividend rate may represent expected dividend payments “leaking” through the un-issued reference asset during the expected life of the warrant or option. Other terms, such as reference asset terms (including dividend stoppers, board election rights, securities registration rights, representations and covenants of the issuer, etc.), perpetual preferred instrument (PPI) terms, forward contract terms, option exercise prices, etc., may also be assumed and/or pre-selected, examples of which may include a dividend rate of the reference asset (e.g. the perpetual preferred stock), a payments rate of any corresponding perpetual preferred instrument, an applicable financing rate of the forward contract, and more.

In some embodiments, TCIA system 120 may apply one or more of the terms or values mentioned above to one or more mathematical, statistical, and/or modeling tools to determine one or more additional transaction terms. For example, TCIA system 120 may apply one or more of the terms or values mentioned above to a volatility-based price estimation model (e.g. a Black Scholes model), or a subjective probability-based price estimation model (e.g. binomial option pricing model), or other price estimation tools (e.g. discounted cashflow or relative value or intrinsic value frameworks) to determine a call option value for the warrants or options of each company. Additionally, TCIA system 120 may determine a negotiated premium for each warrant or option based on the call option value determined for each warrant or option, which may include rounding a call option value up or down.

TCIA system 120 may also determine whether the call option values produced by the applied model and tools is the same as, within a pre-selected difference threshold, etc., of previously assumed or pre-specified warrant target values. In some embodiments, TCIA system 120 may use one or more additional and/or alternative verification and/or validation tools, mechanisms, rules, etc., regarding the call option values and assumed or pre-specified warrant target values. In some embodiments, if/when a difference between a call option value and assumed or pre-specified warrant target value is too large (e.g. above a difference threshold) TCIA system 120 may modify one or more of the assumed or pre-specified terms in accordance with one or more user inputs, rules, etc., until the call option value and assumed or pre-specified warrant target value are the same, within a pre-selected difference threshold, etc.

TCIA system 120 may also determine an exercise profile for a warrant transaction. An exercise profile may include one or more of a variety of terms, attributes, values, etc., such as a warrant notional amount, dividend rate, quantum of dividends per annum, exercise price and exercise price dividend yield of exercise price, warrant premium, total cost, and dividend yield of total price. A notional amount may include a total stated value of a reference asset (e.g. perpetual preferred stock). A dividend rate may include the expected annual dividends of the reference asset, which may be determined or expressed as a percent of the notional amount or the product of the notional amount and dividend yield percent. An exercise price may include the price of exercising the warrant or option to purchase the reference asset. A dividend yield of the exercise price may include the ratio of the reference asset dividend rate and the exercise price. A warrant premium may include a negotiated premium for a corresponding warrant or option. A total cost of a warrant may include a combination of the exercise prices and the negotiated premium, and the dividend yield of the total cost may be a ratio of the reference asset dividend rate and the total cost.

Additionally, or alternatively, TCIA system 120 may validate, verify, etc., a warrant transaction, including one or more individual terms thereof. For example, TCIA system 120 may determine (e.g. based on user input, analysis of user input and/or other information, the application of one or more rules or standards, etc.) how one or more of the terms of one company's warrants should relate to the terms of another company's warrants (e.g. whether the terms are to be the same, whether a particular term should be larger for one company than the corresponding term of another company, whether a difference between company terms is within a pre-selected threshold difference (which may or may not be term specific) etc.). For example, TCIA system 120 may determine company's warrants is to have a larger notional amount and compare the calculated notional amounts to verify that the relative notional amounts are correct. Additionally, TCIA system 120 may compare the notional amounts to verify that a difference between the notional amounts is within a pre-selected notional amount difference threshold. In another example, TCIA system 120 may determine which company's warrants is to have a larger exercise price dividend yield and compare the calculated exercise price dividend yields to verify that the relative exercise price dividend yields are correct. Additionally, TCIA system 120 may compare the exercise price dividend yields to verify that a difference between the exercise price dividend yields is within a pre-selected exercise price dividend yield difference threshold.

In some embodiments, TCIA system 120 may notify a user of the results of the term verification procedures (e.g. by indicating which terms comport with pre-selected rules, standards, expectations, etc.). In some embodiments, when one or more terms are inconsistent with one or more rules, standards, expectations, etc., TCIA system 120 may run various simulations to determine how one or more terms may be modified so that the terms of the warrants and reference assets comply with the previously violated rules, standards, expectations, etc., and notify a user of the results of the simulations (e.g. with suggestions for modifying certain terms). In some embodiments, TCIA system 120 may also, or alternatively, modify one or more terms so that the warrants and reference assets comply with previously violated rules, standards, expectations, etc. For example, TCIA system 120 may be configured with instructions indicating which terms may be automatically modified and/or a degree or amount by which each term may be modified. In some embodiments, TCIA system 120 may be configured with instructions whereby certain terms are prioritized for modification purposes, the modification of certain terms, and/or the amount or degree of acceptable modification, is based on which term, combination of terms, etc., are in violation of pre-selected standards (which may include the degree or amount of violation thereof). In some embodiments, TCIA system 120 may notify a user when a term is automatically modified TCIA system 120, which may include a prompt to accept or reject the modification.

In some embodiments, TCIA system 120 may also, or alternatively, generate exercise value reports based on the terms of the warrant transactions and corresponding reference assets. The exercise value reports may indicate the manner and degree to which certain terms and other values may change under different future risk rates (e.g. rates of return that may or may not happen). For example, an exercise value report may include a notional amount, dividend rate, annual dividend, illustrative present value, exercise price, and illustrative exercise price for a warrant transaction under future risk rate scenarios (e.g. 5%, 10%, and 20% annualized risk rates). TCIA system 120 may also, or alternatively, generate summaries of each warrant transaction, which may include one or more of the terms and values mentioned above. TCIA system 120 may also, or alternatively, generate a summary, report, terms sheet, etc., regarding PPI values for the warrant transaction, which may include the notional amount of the warrant, annual payments percentage, payment status (e.g. cumulative), payment periodicity (e.g. monthly, annually, etc.) maturity duration (e.g. perpetual) whether there is a junior payment stopper, failure to pay terms and conditions, etc.

TCIA system 120 may also, or alternatively, generate a summary, report, terms sheet, etc., regarding a reference asset (e.g. perpetual preferred stock) of a warrant transaction, which may include notional amount, dividend rate, payment status (e.g. cumulative or non-cumulative) dividend period (e.g. monthly, quarterly, annually, etc.) maturity duration (e.g. perpetual) whether there is a junior payment stopper, information regarding failure to declare issues, etc. TCIA system 120 may also, or alternatively, generate a summary, report, terms sheet, etc., regarding a forward purchase agreement for a warrants transaction, which may include the estimated purchase price of the warrant transaction, a financing rate, corresponding financial instrument, forward period, seller, buyer, capitalization factor, floor factor, settlement option, collateral requirement (e.g. encumbered, non-encumbered, etc.).

Process 200 may also include providing the first and second warrant transactions to the first and second company and obtain acquiescence from the first and second company to the first and second transaction (block 230). For example, TCIA system 120 upon determining the terms of the first and second warrant transactions, TCIA system 120 may generate a data sets representing the first and second warrant transactions (including the terms thereof) and may communicate the data sets to the first and second companies (e.g. to user devices, accounts, etc., owned and/or operated by the first and second company). In some embodiments, the data sets may include electronic contracts detailing the parties, terms, conditions, and other details of each transaction (in addition to references to the other transaction of the coupled transactions). The data sets may also indicate the data used by TCIA system 120 to match the companies with one another (e.g. characteristics, capacities, objectives, reasons and aptitude for mutual incentive alignment, etc.) data used to determine the terms of each warrant transaction, etc., as well as explanations for the terms and other details regarding the companies and warrant transactions.

TCIA system 120 may provide each company with instructions for accepting and/or declining the warrant transactions provided by TCIA system 120 (e.g. by signing the electronic contracts). TCIA system 120 may also, or alternatively, provide each company with a way to dispute, further negotiate, etc., the terms of the options transactions, which may include correcting information upon which the warrant transactions (and terms thereof) are based, in which case TCIA system 120 may provide one or more tools, user interface features and functionalities for enabling negotiations between the companies and modifying the warrant transactions until TCIA system 120 receives and confirms acquiescence from both companies regarding the warrant transactions.

Process 200 may also include executing the first and second warrant transactions and creating records thereof (block 240). For example, TCIA system 120 may be configured to execute coupled and customized transactions, between two companies, involving indefinite, yield- and risk-based instruments. In some embodiments, TCIA system 120 may transfer (or cause to be transferred) monetary assets from an account of the first company to the second company in accordance with a first warrant transaction of the coupled options transactions. Similarly, TCIA system 120 may transfer (or cause to be transferred) monetary assets from an account of the second company to the first company in accordance with a second warrant transaction of the coupled warrant transactions.

TCIA system 120 may also, or alternatively, generate documentation memorializing the execution of the transactions, the transfer of the warrants or options to each company, copies of the execute warrant transactions, etc. TCIA system 120 may also create electronic records, entries, or other types of data sets representing the warrant transactions, execution of the warrant transactions, and/or any documentation corresponding thereto. TCIA system 120 may store the electronic records, entries, or other types of data sets in a designated data repository (e.g. company information repository 130, transaction information repository 140, etc.) for later use, reference, analysis, etc.

Process 200 may also include monitoring and managing the first and second warrant transactions to resolution (block 250). For example, when a set of warrant transactions has been executed and a record thereof created, TCIA system 120 may indicate (e.g. in the record) which warrant transactions are still active (e.g. which warrant transactions may still be exercised, and which have expired). TCIA system 120 may monitor the duration of each warrant transaction, and when the duration for a particular warrant transaction has expired, TCIA system 120 may update records of the warrant transaction to indicate that the option has expired. In some embodiments, TCIA system 120 may notify one or more of the transacting companies regarding the expiration of a warrant transaction.

For warrant transactions that are still active, TCIA system 120 may receive an indication from a purchasing company of a warrant transaction that the company has elected to exercise the option to buy the perpetual preferred stock indicated in the warrant transaction. In such a scenario, TCIA system 120 may generate a notification to the selling company of the warrant transaction regarding the purchasing company's decision to exercise the option and purchase the perpetual preferred stock. TCIA system 120 may also, or alternatively, execute the purchase of the perpetual preferred stock, which may include transferring (or causing to be transferred) monetary assets from the purchasing company to the selling company, generating documentation of the decision to exercise the option and/or execution thereof, notifying each company involved in the transaction, etc.

FIG. 3 is a block diagram of example 300 data structures 310-330 for determining capabilities and objectives of a company in accordance with one or more embodiments described herein. As shown, data structure 310 may include information pertaining to a particular company, Company A, data structures 320 may include information pertaining to different types of company capabilities, and data structures 330 may include information pertaining to different types of company objective.

As described herein, TCIA system 120 may receive, retrieve, obtain, produce, etc., information about a company and use the information to match the capabilities and objectives of the company with the capabilities and objectives of another company in a manner that leverages multi-lateral incentive alignment to maximize synergistic value and grown between the companies. A company capability, as described herein, may include a characteristic the relates to an ability, interest, willingness, etc., to purchase a warrant or option interest in another company and/or an ability, interest, willingness, etc., to achieve synergy with another company. An example of a company capability may include the company having monetary capital (e.g. cash) available for purchasing warrants, options, etc. Another example of a company capability may include a ability of the company to experience growth in the near future. Other examples of capabilities may include expertise in certain professional fields, respected reputations in one or more industries, a valuable network of professional alliances or business relationships, etc. A company objective, as described herein, may include a need, preference, goal, or aspiration of the company. Examples of company objectives may include a need to increase monetary capital, a preference to diversify a company's growth opportunities, a goal to penetrate a new industry or market, a desire for expert services closely linked to significant company growth, etc.

According to the techniques described herein, TCIA system 120 may acquire information regarding a particular company, which may include information received directly from the company, input from an user of transaction manager device 115 and/or TCIA system 120, information retrieved from company information repository 130, etc. Additionally, TCIA system 120 may match the company information with predefined data structures defining different company capabilities. For instance, example 300 includes a Monetary Resources data structure that associates a MR metric (e.g. MR_1, MR_2, etc.) with one or more criteria (MRC_1, MRC_2, etc.).

As shown, each MR metric may be associated with other types of information, such as a description (e.g. extra cash) of the company compacity represented by the MR metric. Additionally, or alternatively, each metric may function to uniquely identify the record or entry of attributes associated with one another in a given data structure and/or indicate a degree or disposition to the capability to which the metric corresponds (e.g. MR_1 may be associated with a quantitative value that may be used to indicate ample cash for purchasing warrants, which may be used by TCIA system 120 to assess a company's overall candidacy for warrant transactions and/or match one company with another).

As such, TCIA system 120 may determine company capacities by matching information about the company with criteria associated with a particular type of company capacity. When the company information corresponds to the criteria associated with a particular company capacity, TCIA system 120 may include the company capacity in the data structure representing the company. For example, if TCIA system 120 determines that company information about Company A satisfies criteria MRC_1, MRC_2, and MRC_3, TCIA system 120 may include the corresponding attributes MR_1 and “Extra Cash” with Company A, which may represent that Company A has ample cash for purchase an interest in another company. TCIA system 120 may follow a similar procedure for associating other company capabilities (e.g. significant grown potential, advisor expertise, etc.) with Company A.

TCIA system 120 may also follow a similar procedure for associating Company A with one or more company objectives. For example, assume that TCIA system 120 determines that the company information for Company A satisfies IPC_1, IPC_2, and IPC_3 of the Investment Preference data structure. TCIA system 120 may therefore associate one or more attribute of the that IP entry with Company A (e.g. Diversify Risk (IP_1). Using a similar procedure, assume that TCIA system 120 associates one or more additional company objectives with Company, such as the company objective to Enter New Industry as shown in FIG. 3. As such, TCIA system 120 may determine the capabilities and objectives of a company by obtaining information about the company and matching the company information with pre-defined criteria associated with different capabilities and objectives. In some embodiments, TCIA system 120 may also, or alternatively, determine company capabilities and objectives in one or more additional, alternative, and/or different ways. For example, in some embodiments, TCIA system 120 may assess and determine a company's interest, ability, and willingness to participate in customized and coupled warrant transactions based on direct input from an authorized individual of the company.

FIG. 4 is a block diagram of example 400 data structures 310 and 410-430 for determining optimal companies for engaging in customized and coupled warrant transactions for optimized multi-lateral incentive alignment in accordance with one or more embodiments described herein. As shown, data structure 310 and 410-430 may correspond to Company A, Company X, Company Y, and Company Z, respectively. Additionally, data structure 310 is described above in detail with reference to FIG. 3, and while data structures 410-430 are each arranged in a manner to that of data structure 310, each data structure 310 and 410-430 includes information particular to the entity (e.g. company) to which the data structure corresponds.

For purposes of explaining FIG. 4, assume that Companies A and B are startup companies in different markets. Each company has the potential for significant growth in the immediate future but would nevertheless prefer to mitigate the risk of failure by diversifying their ownership interest in other companies. Additionally, while Company A has a relatively large amount of cash, Company A has been unable to penetrate a new target industry (Industry X) due to a lack of industry reputation and knowledge. By contrast, while Company X has business relationships and knowledge of Industry X, Company X has relatively little cash and would benefit from expert advisory services in a highly specialized field (Field X) in which Company A already operates. p As described herein, TCIA system 120 may receive, retrieve, and/or obtain information regarding multiple companies (e.g. Companies A, X, Y, and Z) and may analyze and process the information to determine the capabilities and objectives of each company. As such, assume that TCIA system 120 determines the capabilities (e.g. significant growth potential, extra cash, advisor expertise in Field A, etc.) and objectives (e.g. preference to mitigate risk, preference to penetrate Industry X, etc.) of Company A as shown in FIG. 4. Similarly, assume that TCIA system 120 determines the capabilities and objectives of Companies X, Y, and Z, where Company X includes capabilities of significant growth potential, knowledge of Industry X, etc., and objectives of mitigating risk, increasing cash, obtaining advisory services in Field A, etc., as is also shown in FIG. 4.

To determine coupled and customized transactions (as described herein) for Company A, TCIA system 120 may analyze, compare, measure, evaluate, etc., the capabilities and objectives of Company A in light of the capabilities and objectives of Companies X, Y, and Z, respectively, to determine the company most suited (and/or suited beyond a predefined threshold metric) to engage with Company A in coupled and customized transactions involving indefinite, yield- and risk-based instruments with optionality to create incentive alignment. Consequently, TCIA system 120 may determine a high probability of synergy between Companies A and X. For example, TCIA system 120 may determine that each company has significant growth potential in the immediate future (Capability ID CID_1) and therefore might satisfy each company's objective of mitigating risk via diversity (Objective ID O_1) by purchasing indefinite, yield- and risk-based instruments with optionality from the other company. TCIA system 120 may also determine that Company X may be limited in its ability to purchase an interest in Company A due Company X's objective to increase cash (Objective ID O_2); however, TCIA system 120 may also determine that Company A has extra cash (Capability ID CID_2) meaning that Company A may be in a good position to purchase an interest in Company X. TCIA system 120 may further determine that Company A purchasing an interest in Company X would result in an increase in cash for Company X, and thus an increased ability of Company X to achieve the objective of mitigating risk via diversification (Objective ID O_1) by purchasing an interest in Company A.

For purposes of further explaining example 300, assume that TCIA system 120 may initially determine that the capabilities and objectives of Company A and Company X are largely complementary in as much as the capabilities of each company appear to satisfy the objectives of the other. However, assume that upon further analysis, TCIA system 120 determines a potential paradox in the objective of Company X to increase cash but also mitigate risk via diversity (e.g. if Company X obtains additional cash, Company X must choose whether to spend the cash to achieve the objective of diversification or not spend the cash to achieve the objective of increasing cash. In some embodiments, TCIA system 120 may determine that such a paradox or conflict exclude Company A and Company X from transacting with one another and may proceed to determine the potential benefit of Company A transacting with another Company (e.g. Company Y, Company Z, etc.).

In some embodiments, instead of aborting the analysis of Companies A and X due to a paradox or conflict, TCIA system 120 may further analyze, compare, processes, etc., the company data of Company A and X to determine whether other relationships between each company's capabilities and objectives may supersede the paradox or conflict (e.g. where additional synergy between company capabilities and objectives are at a level that enables TCIA system 120 to create transactions terms that resolve parodos and conflicts). For example, TCIA system 120 may determine that the growth and success of Company A may depend, at least in part, on an ability of Company A to achieve the objective of penetrating Industry X (Objective ID O_2) which would be augmented (e.g. in terms of probability of success, degree of success, etc.) by the capabilities of Company X regarding Industry X (Capability ID CID_2). Similarly, TCIA system 120 may determine that the growth and success of Company X may depend, at least in part, on an ability of Company X to achieve the objective of obtaining advisory services in Field A (Objective ID O_3) which would be augmented (e.g. in terms of probability of success, degree of success, etc.) by the capabilities of Company A regarding Field A (Capability ID CID_3). In other words, TCIA system 120 may determine upon further analysis that aligning the incentives of Company A and Company X may create enough value within each company, such that it is in Company A's best interest to purchase an interest in Company X at a first amount (e.g. to achieve diversification for Company A) and Company X's best interest to purchase an interest in Company X at a second amount (e.g. to also achieve diversification for Company X) and that the first amount should be somewhat less than the second amount so that Company X may also achieve an increase in cash (which, circling back, creates indirect value in Company A since Company A would have an ownership interest in Company X and therefore be well-benefited by the success of Company X, even despite paying a relatively large amount of cash for an interest in Company X than paid by Company X for an interest in Company A).

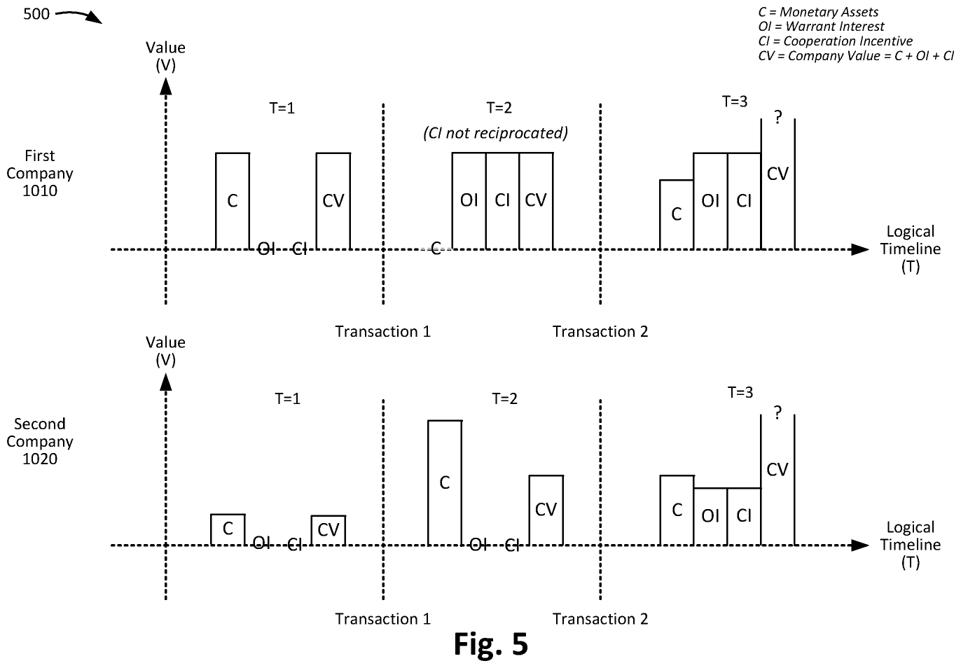

FIG. 5 is a diagram of an example 500 of changes in company values from determining and executing coupled and customized transactions with optionality for optimized multi-lateral incentive alignment in accordance with one or more embodiments described herein. As shown, example 500 includes a chart for first company 510 and second company 520. Each chart includes a horizontal axis corresponding to a logical timeline (T, where T=1, 2, and 3 along logical timeline T) and a vertical axis corresponding to value, where C represents monetary assets (e.g. cash) OI represents option interest in another company, CI represents cooperation incentive, and CV represents overall company value (e.g. C+OI+CI). For purposes of explaining example 500, assume that the respective capabilities (e.g. expertise, reputations, market position, etc.) of first company 510 and second company 520 are synergistic in nature, such that each company is well-positioned to promote the success and value of the other.

At T=1, assume that no warrant transactions have been determined or executed between first company 510 and second company 520. First company 510 includes a moderate amount of monetary assets (C), no optional interest (OI) in other companies, and no cooperation incentive (CI) toward other companies. As such, the company value (CV) of first company 510 T=1 is equal to C. Second company 520 is similarly valued at T=1 but with fewer monetary assets that first company 510.

At T=2, assume that a first warrant transaction (as described herein) has been determined and executed between companies 510 and 520, whereby first company 510 invests C in OI of second company 520. As a result, while C=0 for first company 510, OI and CI are increased to a moderate level for first company 510. The monetary assets of second company 520 increase to a level offset by a decrease in OI due to the purchase of OI in second company 520 by first company 510, and second company 520 experiences a disproportionate increase in CV since first company 510 is incentivized to promote the success and value of second company 520. Notwithstanding an increase in CV of second company 520, and an increase in both OI and CI for first company 510, CV for first company 510 is only equal to OI since CI of first company 510 is not reciprocated by second company 520.

At T=3, assume that a second warrant transaction (as described herein) has been determined and executed between companies 510 and 520, whereby second company 520 invests a portion of C in OI of first company 510. As a result, C increases for first company 510 and decreases for second company 520. The decrease in C for second company 520 is offset by a corresponding increase in OI, resulting in an increase in CI for second company 520 as well. Additionally, since CI is now reciprocal between first company 510 and second company 520, the CV for each company increases well beyond the CVs at T=1. In other words, determining and executing coupled options transactions (e.g. coupled and customized transactions involving indefinite, yield- and risk-based instruments with optionality to create incentive alignment) enables each company to increase in value by aligning the incentives of each company and thereby access synergies therebetween.

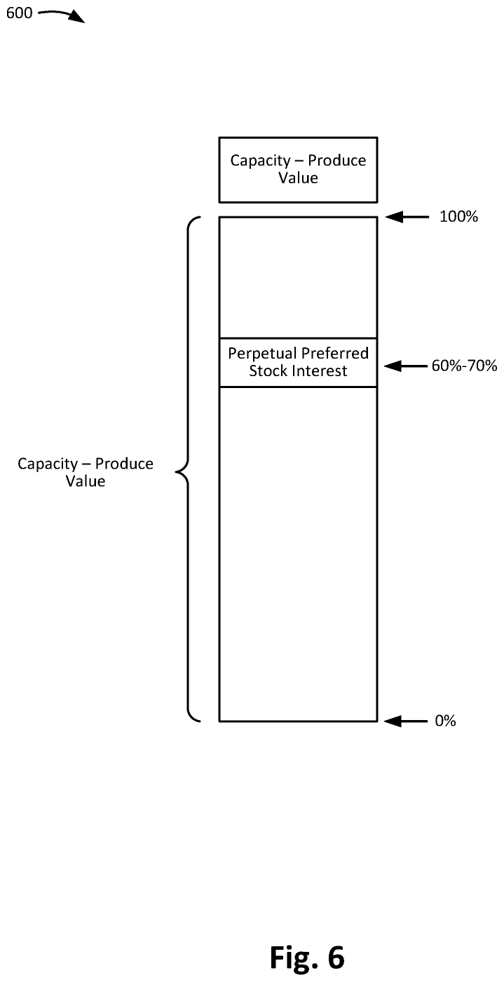

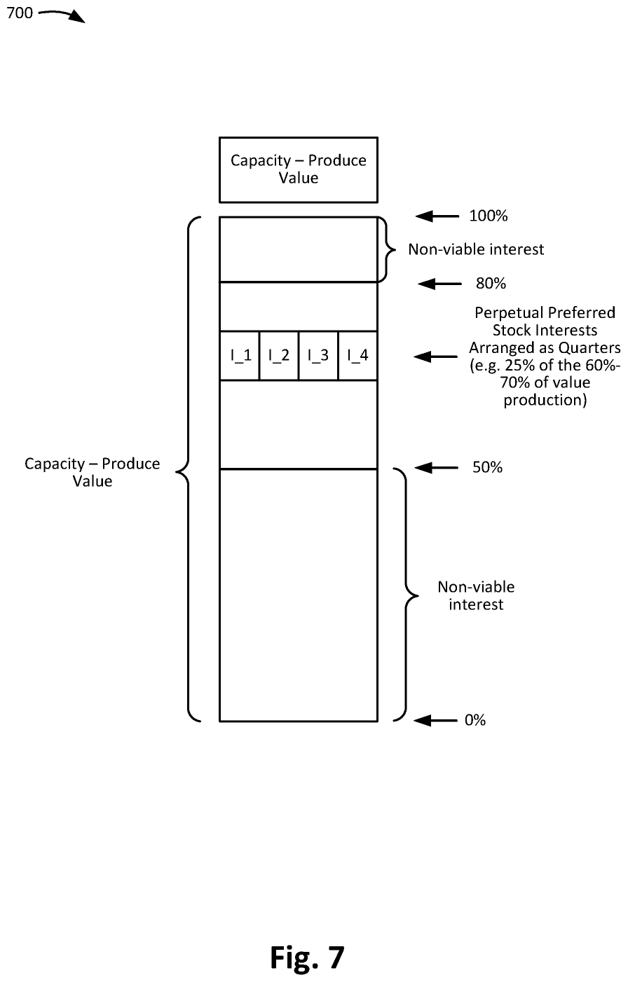

FIGS. 6-7 are block diagrams of examples 600 and 700 of interests in a company that may be referenced in a given option or warrant transaction in accordance with one or more embodiments described herein. As described herein, customized and coupled transactions may include an option to purchase perpetual preferred stock in particular company. However, the terms of the perpetual preferred stock may vary from one transaction to another. In some embodiments, an owner of perpetual preferred stock may create a prioritized ownership interest in the value and/or value generating capacity or ability of another company.

The prioritized ownership interest may be represented by a percentage or percentage range corresponding to the value and/or value generating capacity of the other company. For example, as shown in FIG. 6, perpetual preferred stock may create a relatively simple ownership interest in another company, such as a top 60-70% of the value and/or value generating capacity of the company. By contrast, perpetual preferred stock may create a more complex or nuanced interest in another company. For example, as shown in FIG. 7, an interest in the top 60-70% value and/or value generating capacity of the company may be partitioned into distinct interests (e.g. I_1, I_2, etc.) such that perpetual preferred stock referencing only a portion of the top 60-70% value may be sold to a particular company. As such, TCIA system 120 may customize the terms of coupled and customized transactions, as described herein, based on the varying needs, preferences, standards, etc., of company involved in buying and selling indefinite, yield- and risk-based instruments with optionality.

In some embodiments, when determining an appropriate ownership interest to reference in a option or warrant transaction TCIA system 120 may apply one or more standards, rules, templates, thresholds, etc., to help ensure that an appropriate ownership interest is being referenced. For example, as also shown in FIG. 7, TCIA system 120 may be configured to disregard exceptionally high ownership interests (e.g. between the top 80-100%) and/or exceptionally low ownership interests (e.g. between the bottom 0-50%) when determining appropriate ownership interests. Selling warrants or options referencing highly prioritized ownership interests may be disagreeable to the company selling the warrant or option interest, and buying warrants or options referencing low prioritized ownership interests may be disagreeable to the company purchasing the warrant or option interest. As such, TCIA system 120 may apply one or more standards, rules, templates, thresholds, etc., to help ensure that an appropriate ownership interest is being referenced coupled and customized transactions.

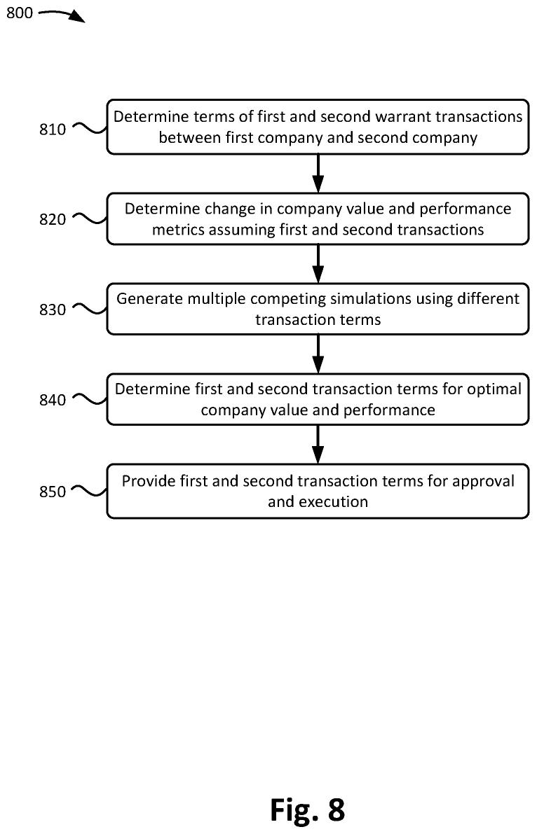

FIG. 8 is a flowchart diagram of an example process 800 for determining optimal terms for customized and coupled warrant transactions in accordance with one or more embodiments described herein. In some implementations, process 800 may be implemented by TCIA system 120. In some embodiments, some or all of process 800 may be performed by one or more other systems or devices, including one or more of the devices of FIG. 1. While FIG. 8 represents process 800 as a sequence of operations, the sequence of the operations, arrangement of the operations, etc., does not limit the scope of the techniques described herein. Additionally, one or more of the operations of process 800 may be combined, augmented, enhanced, replaced, performed in the context of, etc., one or more other operations, features, aspects, etc., of the techniques described herein.

As shown, process 800 may include determining the terms of a first warrants transaction and a second warrants transitions between a first company and a second company. For example, as described herein, TCIA system 120 may determine the terms of coupled and customized warrant transactions that each reference indefinite, yield- and risk-based instruments (e.g. each reference perpetual preferred stock) to create incentive alignment between two companies. Examples of such terms may include a warrant target value, call option value, negotiated premium, references asset value and dividend rate, exercise price, and more.

Process 800 may include determining a change in company value and performance metrics assuming execution of the first and second transactions (block 820). For example, TCIA system 120 may use one or more modeling, forecasting, simulating, and/or measuring tools or techniques configured to determine the effect (e.g. with a selected level of confidence) that the first and second transactions may have on each of the first and second company. As an example, TCIA system 120 may analyze the characteristics, capabilities, objectives, and/or other types of information of a first and second company to determine a probability and degree of success of a first company and a second company prior to mutually executing warrant transactions. Upon determining the terms of warrant transactions between the companies (as described herein) TCIA system 120 may estimate, forecast, measure, etc., how the warrant transactions may change (if at all) the value and performance of each company. As described herein, TCIA system 120 may be configured to apply one or more tools, techniques, standards, indexes, etc., (which may involve historical company performance information) to accurately quantify qualitative attributes, conditions, and other factors for use in modeling, forecasting, simulating, etc.

Process 800 may also include generating multipole competing simulations using different transaction terms (9block 830). For example, TCIA system 120 may change one or more terms of the initially determined transactions and use one or more modeling, forecasting, simulating, and/or measuring tools or techniques to determine a probability and degree of success of a first company and a second company given the newly specified transaction terms, such that the value-generating impact of the terms of the first set of transactions may be compared to that of the second set of transactions. TCIA system 120 may change one or more of the terms again to create yet another competing simulation, and so on, until TCIA system 120 has generated a large number of instances that associate different sets of transaction terms with different sets of company value and performance metrics. In some embodiments, the accuracy of the value and performance metrics of a given set of transaction terms may be enhanced by TCIA system 120 may running multiple performance simulations for the same set of transaction terms and using some combination (each an average) of the performance simulation outcomes as the value and performance metrics for that set of transaction terms.

Process 800 may also include determining first and second transaction terms for optimal company value and performance (block 840). For example, TCIA system 120 may analyze and compare each performance simulation to determine which set of transaction terms correspond to the greatest increase in value and performance between the companies. In some embodiments, TCIA system 120 may determine optimal transaction terms based on which transaction terms is associated with the largest overall increase in company value and performance. In some embodiments, TCIA system 120 may determine optimal transaction terms by disregarding any scenario associated with a decrease in either company's value and performance. In some embodiments, TCIA system 120 may determine optimal transaction terms by disregarding any scenario associated with either company failing to achieve a minimum threshold increase in value and performance. In some embodiments, TCIA system 120 may determine optimal transaction terms by applying different requirements, thresholds, etc., to each company.

Process 800 may also include providing the first and second transaction terms for approval and execution (block 850). For example, TCIA system 120 may communicate the first and second transaction terms to a transaction manager of TCIA system 120 along with a prompt to accept or reject the proposed transaction terms, change the terms of the transaction, request additional simulations, etc. Upon receiving approval, TCIA system 120 may provide the proposed transaction terms to designated representatives of each of the transacting companies, along with a prompt to accept, reject, and/or propose alterations to the proposed transaction terms. If/when TCIA system 120 each company agrees to the proposed transaction terms, TCIA system 120 may generate electronic contracts and supporting transaction documents for executing the transactions, provide each company with the contracts and supporting transaction documents for execution, receive confirmation of the companies executing the electronic contracts, and causing the transactions to be executed, which may include causing appropriate transfers of monetary assets between the companies, generating and providing each company with documentation of the warrants purchased, etc.

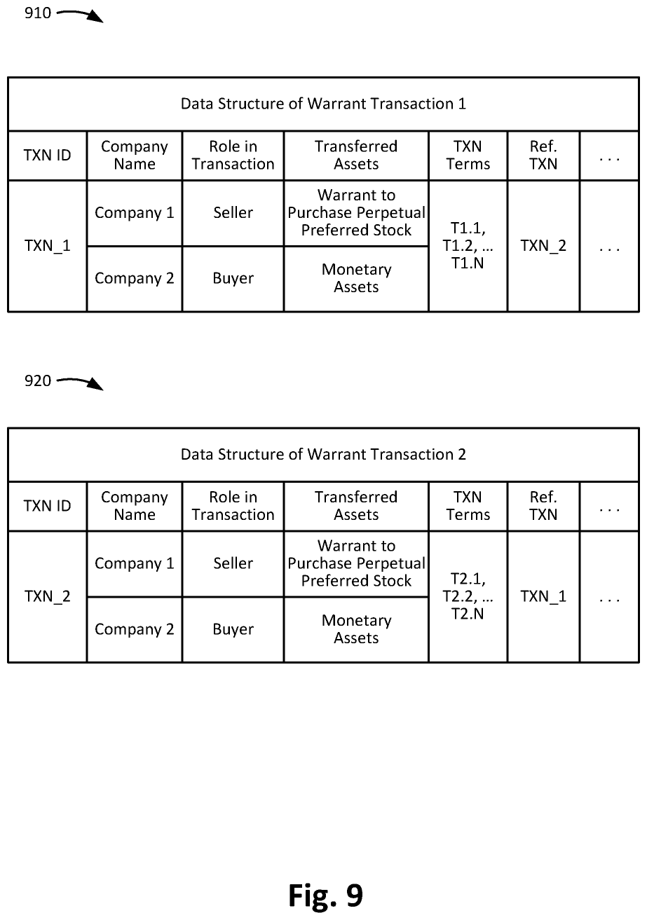

FIG. 9 is a block diagram of example data structures 910 and 920 for recording customized and coupled warrant transactions for optimized incentive alignment in accordance with one or more embodiments described herein. As shown, each data structure 910 and 920 may include a transaction ID (e.g. TXN_1, TXN_2, etc.), company names (e.g. Company 1, Company 2, etc.), a role of each company in the transaction (e.g. Buyer or Seller), assets involved in the transaction (e.g. option to purchase perpetual preferred stock and monetary assets), transaction terms (e.g. T1.1, T1.2, etc.), and a reference transaction identifier (TXN_1, TXN_2, etc.) whereby each transaction is logically associated with the other. Data structures 9910 and 920 are provided for example purposes only. In practice, coupled and customized transactions, as described herein, may be stored, recorded, etc., in one or more of a variety of formats, arrangements, and structures, which may include less, additional, alternative, and/or different information, including titles, attributes, values, etc., than those illustrated in FIG. 9.

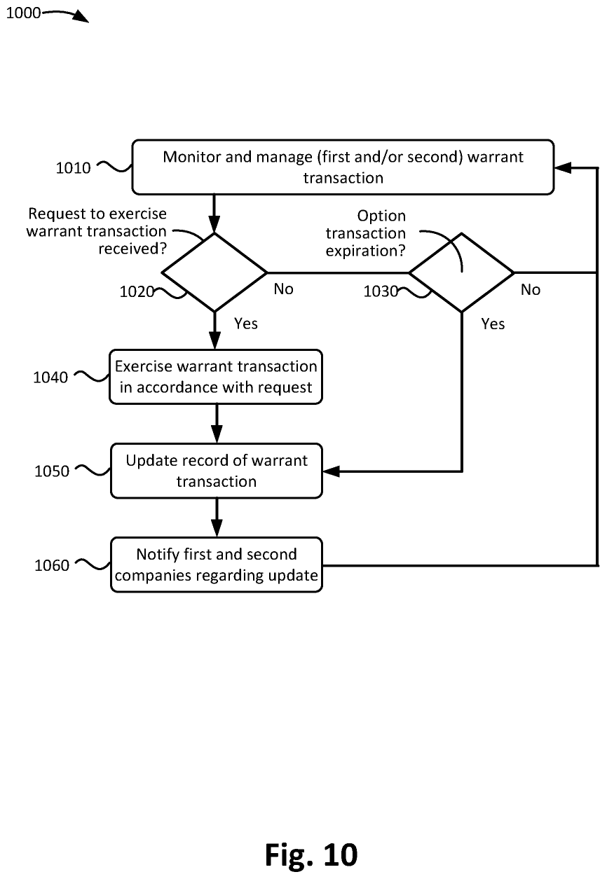

FIG. 10 is a flowchart diagram of an example process 1000 for monitoring, managing, and executing warrants according to one or more of the techniques described herein. In some implementations, process 1000 may be implemented by TCIA system 120. In some embodiments, some or all of process 1000 may be performed by one or more other systems or devices, including one or more of the devices of FIG. 1. While FIG. 10 represents process 1000 as a sequence of operations, the sequence of the operations, arrangement of the operations, etc., does not limit the scope of the techniques described herein. Additionally, one or more of the operations of process 1000 may be combined, augmented, enhanced, replaced, performed in the context of, etc., one or more other operations, features, aspects, etc., of the techniques described herein.

As shown, process 1000 may include monitoring and managing a first and second warrant transaction (block 1010). For example, upon executing customized and coupled transactions as described herein, TCIA system 120 may store records of the transactions and provide monitoring and management services regarding the transactions. For example, TCIA system 120 may periodically determine whether a request to exercise a warrant has been received (e.g. from an individual authorized to act on behalf of the company) (block 1020). In some embodiments, instead of periodically checking whether a request has been received, TCIA system 120 be configured to monitor and manage warrant transactions and upon receiving a request to execute a warrant verify that the warrant has not expired and then proceed to execute the warrant and so on. Additionally, or alternatively, as part of monitoring and managing warrant transactions, TCIA system 120 may be configured to periodically determine which warrants have expired and proceed to update the corresponding records, notify the corresponding parties, etc.

Referring again to FIG. 10, when a request has not been received (block 1020—No), TCIA system 120 may determine whether the warrant has expired (block 1030) and will continue providing monitoring and management services for the warrant so long as the warrant has not expired (block 1030—No). When the warrant has expired (block 1030—Yes), TCIA system 120 may update the corresponding transaction record (block 1050) and proceed as shown in FIG. 1000. When a request to execute a warrant has been received (block 1020—Yes), TCIA system 120 may cause the warrant to be executed in accordance with the request (block 1040). In some embodiments, this may include TCIA system 120 prompting, enabling, and/or otherwise causing the buying company to transfer monetary assets, per the execution price, to the selling company, and generating appropriate documentation for completion of the transaction and providing the documentation to the appropriate parties.

Process 1000 may also include TCIA system 120 updating the record of the warrant transaction (block 1050) which may include updating the record to indicate that the warrant has been executed, payment has been received, documentation has been generated and communicated to the appropriate parties, etc. As shown, when a warrant transaction record is updated (whether because a warrant has expired or been executed) TCIA system 120 may notify the corresponding companies that the warrant transaction record has been updated, which may include an indication of the reason for the update and the current status of the warrant transaction (block 1060). In some embodiments, TCIA system 120 may provide documentation, notifications, etc., regarding the execution, expiration, or other transaction status change, to one or more additional, alternative, and/or different individuals or organizations, including a transaction manager of TCIA system 120, government agency, regulatory organization, etc.

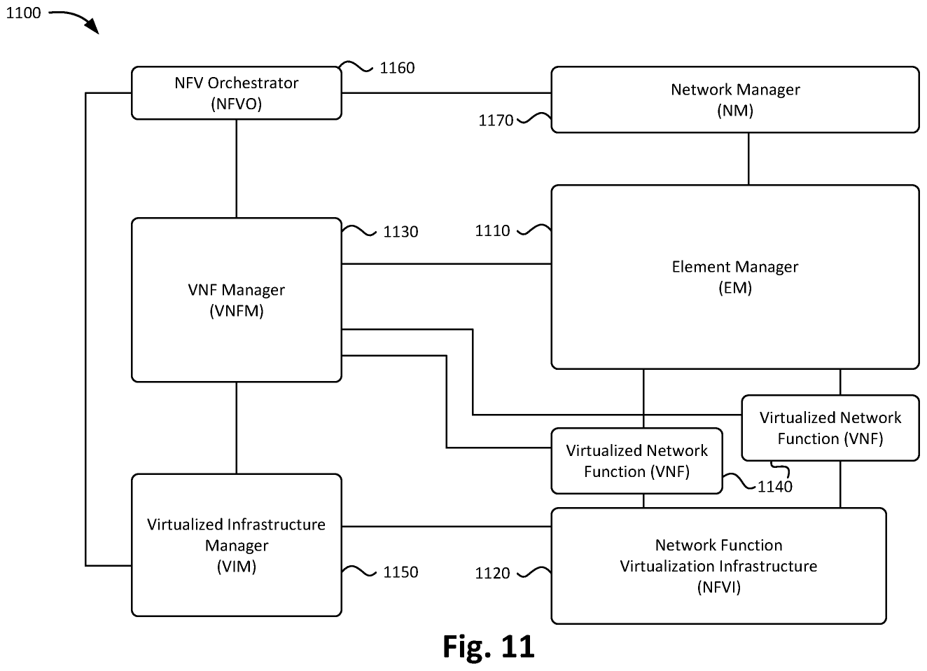

FIG. 11 is a block diagram illustrating components of a system 1100 configured to support network function virtualization (NFV) in accordance with one or more embodiments described herein. As shown, system 1100 may virtualized infrastructure manager (VIM) 1150, network function virtualization infrastructure (NFVI) 1120, VNF manager (VNFM) 1130, virtualized network functions (VNFs) 1140, element manager (EM) 1150, NFV orchestrator (NFVO) 1160, and network manager (NM) 1170.

VIM 1150 may be configured to manage resources of the NFVI 1120, which may include physical or virtual resources (e.g. processor capacity, memory capacity, storage capacity, etc.) and applications used to execute the system 1100. VIM 1150 may be configured to manage a life cycle of virtual resources with the NFVI 1120 (e.g. creation, maintenance, and/or tear down of virtual machines (VMs) associated with one or more physical resources) track VM instances, track and/or manage performance, fault, and security of VM instances and associated physical resources, and/or expose VM instances, and associated physical resources, to one or more other management systems.

VNFM 1130 may be configured to manage VNFs 1140, which may be configured execute one or more functions associates one or more types of network devices. VNFM 1130 may manage a life cycle of VNFs 1140 and track and/or manage performance, fault, and security of the virtual aspects of VNFs 1140. EM 1150 may track and/or manage the performance, fault, and security of functional aspects of VNFs 1140. The tracking data from VNFM 1130 and EM 1150 may comprise, for example, performance measurement (PM) data that may be used by VIM 1150 and/or NFVI 1120 in performance of their respective functions. VNFM 1130 and EM 1150 may be configured to increase and/or decrease the quantity of VNFs 1140 of system 1100.

NFVO 1160 may be configured to coordinate, authorize, release, and engage resources of NFVI 1120 in order to, for example, provide requested service. NM 1170 may be configured to provide a package of end-user functions with the responsibility for the management of a network, which may include network elements with VNFs 1140, non-virtualized network functions, or both. In some embodiments, management of VNFs 1140 may occur via the EM 1150).

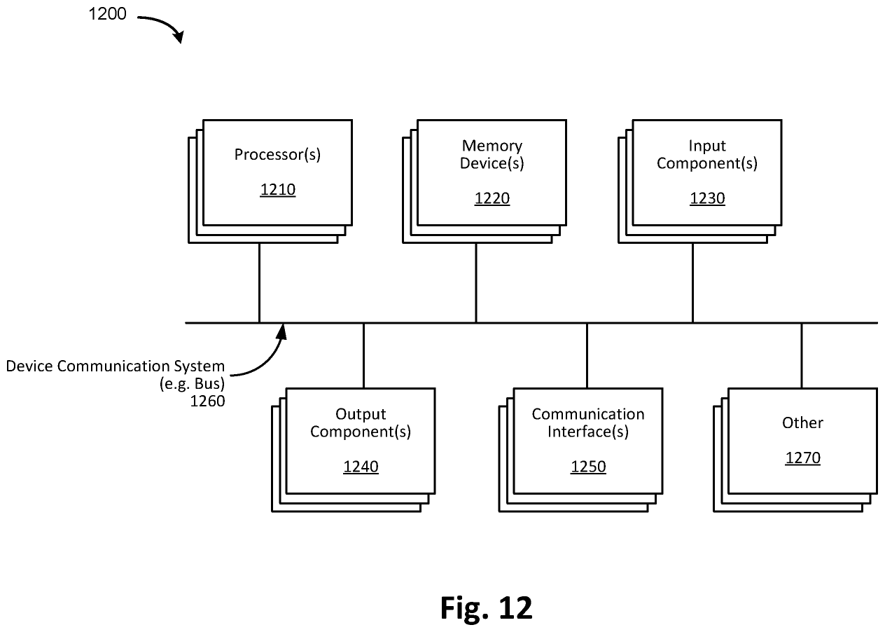

FIG. 12 is a diagram of example components of a device 1200 in accordance with one or more embodiment described herein. Each of the devices illustrated in FIG. 1 may include one or more devices 1200. Device 1200 may include one or more processors 1210, memory devices 1220, input components 1230, output components 1240, communication interface 1250, and/or one or more other types of device components (such as a power source). Additionally, one or more of the components of device 1200 may interconnected via a bus or another type of device communication system. In another implementation, device 1200 may include additional, fewer, different, or differently arranged components than is shown. As described herein, a component may be implemented by hardware circuitry, software logic, and/or some combination thereof.

Processor 1210 may include a processor, microprocessor, or processing logic that may interpret and execute instructions that may be stored in one or more locations within device 1200 and/or received by device 1200 from an external source. Memory device 1220 may include any type of dynamic storage device that may store information and instructions by executable by processor 1210, and/or any type of non-volatile storage device that may store information for use by processor 1210.

Input component 1230 may include a device or another type of mechanism configured to enable a user of device 1200 to directly input information. Examples of an input component may include a keyboard, microphone, keypad, button, switch, sensor, accelerometer, compass, etc. Output component 1240 may include a device or another type of mechanism configured to output or otherwise communicate information to the user. Examples of output component 1240 may include a display, speaker, one or more light emitting diodes (LEDs), vibration device, etc. In some embodiments, output component 1240 may include a device configured to output information to the user via another device.

Communication interface 1250 may include any transceiver-like device or mechanism configured to enable device 1200 to communicate with one or more other networks, systems, or devices. For example, communication interface 1250 may include an Ethernet interface, optical interface, coaxial interface, and/or another type of interface device configured to communicate over a physical (e.g. wired) medium. Communication interface 1250 may include a wireless communication device, such as an infrared (IR) transceiver, cellular radio, Bluetooth radio, and/or another type of interface device configured to communicate over a wireless medium. In some embodiments, a wireless communication device may be coupled to an external device, such as a remote control, wireless keyboard, mobile telephone, etc. In some embodiments, device 1200 may include multiple communication interfaces 1250, such as an optical interface, Ethernet interface, and cellular interface.

Device 1200 may perform certain operations described above. For example, device 1200 may perform these operations in response to processor 1210 executing software instructions stored in a computer-readable medium, such as memory 1220. A computer-readable medium may be defined as a non-transitory memory device. A memory device may include space within a single physical memory device or shared memory spread across multiple physical memory devices. Software instructions may be read into memory 1220 from another computer-readable medium and/or from another device. The software instructions stored in memory 1220 may cause processor 1210 to perform one or more operations, processes, etc., in accordance with the techniques described herein. Alternatively, hardwired circuitry may be used in place of, or in combination with, software instructions to implement operations and processes described herein. Thus, implementations, described herein, are not limited to any specific combination or arrangement of hardware and software.

In the preceding description, various preferred embodiments have been described with reference to several figures. It will, however, be evident that various modifications and changes may be made thereto, and additional embodiments may be implemented, without departing from the broader scope set forth by the overall techniques described herein. As such, the figures and corresponding descriptions, presented herein, are to be regarded and interpreted as illustrative rather than restrictive of the broader scope of the techniques described herein.

For example, while a series of lines, arrows, and/or blocks have been described with regard to FIGS. 2-4 and 8-10, the order of the blocks and arrangement of the lines and/or arrows may be modified in other implementations. Further, non-dependent blocks may be performed in parallel. Similarly, while series of communications may have been described with regard to several of figures, the order or nature of the communications may be modified in other implementations. For example, while series of signals and/or operations have been described with respect to FIGS. 2, 4, 8, and 10 the order of the signals, operations, processes, etc. may be modified in other implementations. Further, non-dependent signals may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein. Additionally, certain portions may be implemented as “logic” that performs one or more functions. This logic may include hardware, such as an application-specific integrated circuit (ASIC) or a field-programmable gate array (FPGA), or a combination of hardware and software.

Even though particular combinations of features are recited in the claims and/or described herein, these combinations are not intended to be limiting. Indeed, many of these features may be combined in ways not specifically recited in the claims and/or express described herein. Further, no element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used.

1. A server device, comprising:
a memory device containing program instructions; and
one or more processors, configured to execute the program instructions, to:
identify a first company and a second company to engage in a first warrant
transaction and a second warrant transaction,
the first warrant transaction includes the first company purchasing warrants from the second company and
the second warrant transaction include the second company purchasing warrants from the first company;
determine terms of the first warrant transaction and terms of the second warrant transaction based on company capabilities and objectives of the first company and company capabilities and objectives of the second company; and
execute the first warrant transaction and the second warrant transaction to align the interests of the first company with the second company and the interests of the second company with the first company.

2. The apparatus of claim 1, wherein the first warrant transaction references perpetual preferred stock in the second company.

3. The apparatus of claim 1, wherein the second warrant transaction references perpetual preferred stock in the first company.

4. The apparatus of claim 1, wherein the expiration date of the first warrant transaction is different than the expiration date of the second warrant transaction.

5. The apparatus of claim 1, wherein a purchase price of the first warrant transaction is different than a purchase price of the second warrant transaction.

6. The apparatus of claim 1, wherein a purchase price of the first warrant transaction and a purchase price of the second warrant transaction are each based on a level of anticipated growth of the first company relative to a level of anticipated grown of the second company, the level of anticipated growth of the first company being different than the level of anticipated grown of the second company.

7. A computer-readable medium containing program instructions for causing one or more
processors, associated with a server device, to:
identify a first company and a second company to engage in a first warrant transaction and a second warrant transaction,
the first warrant transaction includes the first company purchasing warrants from the second company and
the second warrant transaction include the second company purchasing warrants from the first company;
determine terms of the first warrant transaction and terms of the second warrant transaction based on company capabilities and objectives of the first company and company capabilities and objectives of the second company; and
execute the first warrant transaction and the second warrant transaction to align the interests of the first company with the second company and the interests of the second company with the first company.

8. The computer-readable medium of 7, wherein the first warrant transaction references perpetual preferred stock in the second company.

9. The computer-readable medium of 7, wherein the second warrant transaction references perpetual preferred stock in the first company.

10. The computer-readable medium of 7, wherein the expiration date of the first warrant transaction is different than the expiration date of the second warrant transaction.

11. The computer-readable medium of 7, wherein a purchase price of the first warrant transaction is different than a purchase price of the second warrant transaction.

12. The computer-readable medium of 7, wherein a purchase price of the first warrant transaction and a purchase price of the second warrant transaction are each based on a level of anticipated growth of the first company relative to a level of anticipated grown of the second company, the level of anticipated growth of the first company being different than the level of anticipated grown of the second company.

13. A method, performed by a server device, the method comprising:
identifying a first company and a second company to engage in a first warrant transaction and a second warrant transaction,
the first warrant transaction includes the first company purchasing warrants from the second company and
the second warrant transaction include the second company purchasing warrants from the first company;
determining terms of the first warrant transaction and terms of the second warrant transaction based on company capabilities and objectives of the first company and company capabilities and objectives of the second company; and
executing the first warrant transaction and the second warrant transaction to align the interests of the first company with the second company and the interests of the second company with the first company.

14. The method of claim 13, wherein the first warrant transaction references perpetual preferred stock in the second company.

15. The method of claim 13, wherein the second warrant transaction references perpetual preferred stock in the first company.

16. The method of claim 13, wherein the expiration date of the first warrant transaction is different than the expiration date of the second warrant transaction.

17. The method of claim 13, wherein a purchase price of the first warrant transaction is different than a purchase price of the second warrant transaction.

18. The method of claim 13, wherein a purchase price of the first warrant transaction and a purchase price of the second warrant transaction are each based on a level of anticipated growth
of the first company relative to a level of anticipated grown of the second company, the level of anticipated growth of the first company being different than the level of anticipated grown of the second company.

19. A server device, comprising:
a memory device containing program instructions; and
one or more processors, configured to execute the program instructions, to:
determine transaction characteristics corresponding to a plurality of company entities;
match, based on the transaction characteristics, a first company entity, of the plurality of company entities, with a second company entity of the plurality of company entities;
determine, based on the transaction characteristics of the first company entity and the second company entity, warrant transaction terms to optimize incentive alignment between the first company entity and the second company entity; and
generate warrant transaction proposal between the first company entity and the second company entity in accordance with the warrant transaction terms.

20. The server device of claim 19, wherein the one or more processors are further configured to:
match, based on the transaction characteristics, the first company entity, of the plurality of company entities, with a third company entity and a fourth company entity of the plurality of company entities.

21-23. (canceled)
